(19) United States
(12) Patent Application Publication
(10) Pub. No.: US 2019/0084180 A1
(43) Pub. Date: Mar. 21, 2019

(54) INDUSTRIAL WOOD CHIPPER KNIFE AND METHOD FOR MANUFACTURING AN INDUSTRIAL WOOD CHIPPER KNIFE

(71) Applicant: Cortex North Ammerican Corporation, Portland, OR (US)

(72) Inventor: Trenton Lee Carpenter, Portland, OR (US)

(21) Appl. No.: 16/093,833

(22) PCT Filed: Apr. 15, 2016
(86) PCT No.: PCT/CL2016/050017

§ 371 Date: Oct. 15, 2018

(51) Int. Cl. B27G 13/04; B27L 11/00

(52) U.S. Cl. CPC B27G 13/04; B27L 11/005

(57) ABSTRACT

A chipper has a knife clamped between a clamp and a counter knife that sits on a holder. The knife, damp, and counter knife are collectively positioned in a machined area formed in a holder that is in turn within a larger recess formed in a chipping disk or chipping drum.

A first fastener secures the knife holder to the chipping disk, a second fastener secures the clamp to the knife holder, and a third fastener secures the counter knife lo the knife holder. The knife comprises a ridge which is formed by the termination in two straight lines which form a triangle shape on the bottom of the knife. These straight lines reduce the manufacturing cost of the knife and provide support for the knife to locate. The knife is also manufactured without 100% grinding of all services, which is unique in that this reduces manufacturing costs dramatically.

### FIELD OF THE INVENTION

This invention relates to improvements in the manufacturing of reversible chipper knives and an optimized design for the ridge on the bottom of the knife, which improves knife stability as well as reduces the manufacturing costs.

### BACKGROUND OF THE INVENTION

Chippers are machines capable of chipping various sizes and types of wood species into particles known generally as chips. The chips are used, primarily, as raw material for pulp manufacturing. The wood species that are cut into chips for pulp production vary greatly in size and type, i.e. some woods are very hard and some arc very soft. There arc two broad areas of chip production; primary chip manufacturing where chips are cut out of whole log trunks, and secondary chip manufacturing where chips are produced from residual wood, i.e. trimmings from sawmills.

In recent years, disposable or reversible knives have gained acceptance in the industry due to improved safety and higher quality steel, but such acceptance has been limited due to knife stability and durability issues within the knife system, as well the high operating costs associated with disposable chipper knives. These challenges can cause significant downtime in chipping machines and reduce the production of high quality wood chips. The high costs have prohibited the disposable (reversible) knife technology to penetrate markets where the technology would provide large benefits.

The known designs have a tendency to allow the knife lo move or slip out of position. Other challenges have been knives bending or twisting, which again reduces production time. Known reversible knife systems are subject to over-torqueing when the damp that holds the knife is tightened down, or under torqueing and allowing the knife to come lose during operation. Due to the small surface area between the knife and the clamp, the clamp springs down more than anticipated and the clamping force is concentrated on the lower heel of the knife at the clamp contact surface abutting the knife. Thus, the upper part of the clamping surface is subjected to a decreased clamping pressure and functional problems occur. For example, wood fiber can enter into the space between a poorly clamped knife and its counter knife, thereby further degrading the performance of the knife.

Additional challenges with the prior art include the Chilean patent 49.918 which is a larger knife that has an aggressive deflection ridge that breaks up the high quality wood chips. This action reduces the value of the wood chips during the wood chipping process and does not allow the wood chips to follow the natural flow of the cut. The knife disclosed by patent 49.918 has one flat holding point on the top of the knife. This permits the accumulation of material between the knife and incorrect clamping force discussed previously. When a knife begins to vibrate or move, the edge life decreases rapidly and the quality of the wood chips decrease. The large size of this knife creates a leveraging action which also increases knife movement and reduces the duration of the edge. The unique characteristic of patent 49.918 is the two rounded indexing indentions (R, S Q on FIG. 3) on each side of the ridge which are used to locate the knife into position. These guiding services, also called indexing features, provide a separation between the wood chip and the knife before the wood chip impacts the aggressive ridge on this knife. This feature reduces the control of the wood chip and can break the wood chips into undesirable small pins chips.

The Chilean Patent 41.475, seen in FIG. 8, uses a similar design concept as 49.918 with a reversible knife and a deflector ridge on the bottom of the knife. This iteration of the patent has many challenges because of the extreme force on each side of the knife, which has caused the knife to break in half. In another iteration of this knife, it is shaped like a Z. The large Z shaped knife has major stress concentration points that increase the risk of the knife breaking.

Additional designs have attempted to reduce the size of the knife and to eliminate these problems, such as WO2009054768 (see FIG. 4). This knife design offers a much smaller knife, or low-volume knife, and a smoother chip transition ridge; however, the upper clamping portion is extremely wide and limits the thickness of the knife. This limited thickness causes the knife to twist and bend after heavy wood chipping operations. Also, the clamping on the top of the knife makes contact with the knife in 3 points, which is extremely difficult to guarantee proper clamping at all times. U.S. Pat. No. 8,082.958 specifically claims a concave area on the bottom of the knife leading to the crest of the edge on the knife. This concave design increases manufacturing costs by requiring a special form grinder and the new invention specifically uses straight lines on the ridge culminating at the crest to form a rounded point.

The ridge on all of the above mentioned knives is concave or rounded. This form dramatically increases the manufacturing costs because it is made with a custom tool or on a high cost form grinding machine. These machines are very expensive and the grinding operation in the manufacturing accounts for a major source of the manufacturing cost. These knives use these form grinders to grind all sides of the knife. Grinding the complete surface of the knife increases the cost and therefore reversible knives are sold at a much higher price. Grinding costs typically account for 40% of the manulactunng cost of the knife.

The optimized size of the knife reduces the levarage action caused during heavy loads on the knife System. The invention provides improved knife stability with the multi angled damping area on the top of the knife, combined with the two contact zones on the bottom of the knife, which increases the stability near the edge of the knife during cutting. The fist line on the ridge provides a smooth transition for the wood chips and reduces the risk of damaging the wood chips. The damping width provides and increased thickness in the knife at the most critical area, which further reduces the risk of the knife breaking or bending.

### SUMMARY OF THE INVENTION

The object of this invention is to avoid deficiencies of the prior art and to introduce a chipper knife which has the optimized geometry and size compared to the prior art and can be manufactured at a more competitive price with the elimination of additional machining on over 50% of the surface after the heat treatment of the knife.

The present invention refers to a reversible knife and knife system for wood chipping with a smooth surface finish near the knife edge and improved stability, that allows for enhanced knife life (duration) and improved wood chipping performance. The top side of the knife utilizes a dual angle clamping style, where in which the knife is contacted on two distinct angles on each side of the top portion of the knife, providing a stable knife that will last longer than competing knives, while the bottom of the knife is defined by having two parallel lines that end in a ridge in the middle of the knife that is composed of straight lines, the angle between these lines is over 90 degrees.

### DESCRIPTION OF THE FIGURES

FIG. 1 shows a reversible chipper knife according to an embodiment of the invention.

FIG. 2 shows the reference lines used to define the position and description of the elements of a reversible chipper knife according to an embodiment of the invention.

FIG. 3 shows an illustration of reversible chipper knife according to the prior art.

FIG. 4 shows an illustration of another reversible chipper knife according to the prior art.

FIG. 5 shows the restricted grinding, or machining area, that is part of invention for the method for manufacturing a reversible chipper knife according to an embodiment of the invention.

FIG. 6 shows one iteration of the reversible chipper knife without the indentions on the bottom of the knife, according to an embodiment of the invention.

FIG. 7 shows the first iteration of the reversible chipper knife includes the indentions on the bottom, according to an embodiment of the invention.

FIG. 8 shows a knife with a single ridge on the bottom of the knife, according to the prior art.

FIG. 9 shows the the grinding area after heat treatment with the manufactured method, according to an embodiment of the invention.

FIG. 10 shows the grinding area of the manufacturing method, according to an embodiment of the invention.

FIG. 11 shows another view of the the limited grinding area of the knife after heat treatment.

### DETAILED DESCRIPTION OF THE INVENTION

The knife and manufacturing process of the present invention is an improvement on existing designs by optimizing the size of the knife to eliminate twisting and bending associated with patent U.S. Pat. No. 8,082.958 and the leverage action that causes 49.918 to lose stability, while also drastically reducing the manufacturing cost by eliminating the need for expensive form grinders.

The current invention solves the problem of twisting and bending of the knife by utilizing a multy angle clamping zone that is narrower than patent U.S. Pat. No. 8.082.958 yet provides equal or greater clamping force. The invention provides more contact on the bottom of the knife, which allows the clamping area to be narrower and add thickness to the knife. This added thickness prevents the knife from bending or twisting during heavy operation.

The leverage action caused by the prior art in 49.918, which g increases the force on the knife and requires a large clamp to hold the knife in place, is not present with the new invention which utilizes an optimum sized knife, approx., 40% smaller than 49.918e. The indexing features on 49.918, which lead to a concave and aggressive ridge that creates small pin chips, is eliminated with the invention. The invention solves the problem of increasing pin chips with an aggressive ridge by optimizing this transition angle, which is a flat line and is over 90 degrees from the line on the bottom of the knife. This permits the wood chips to continue their natural path towards the back of the chipper disc and reduces the impact on the high quality chips.

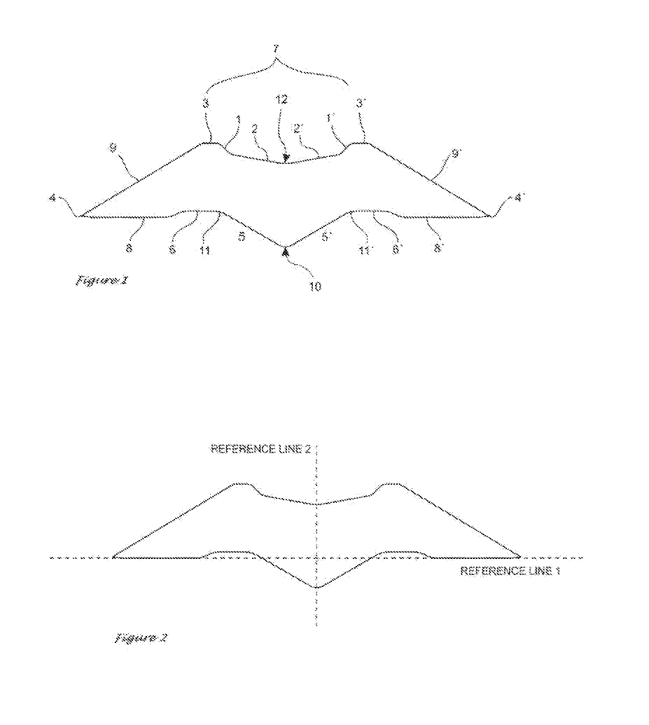

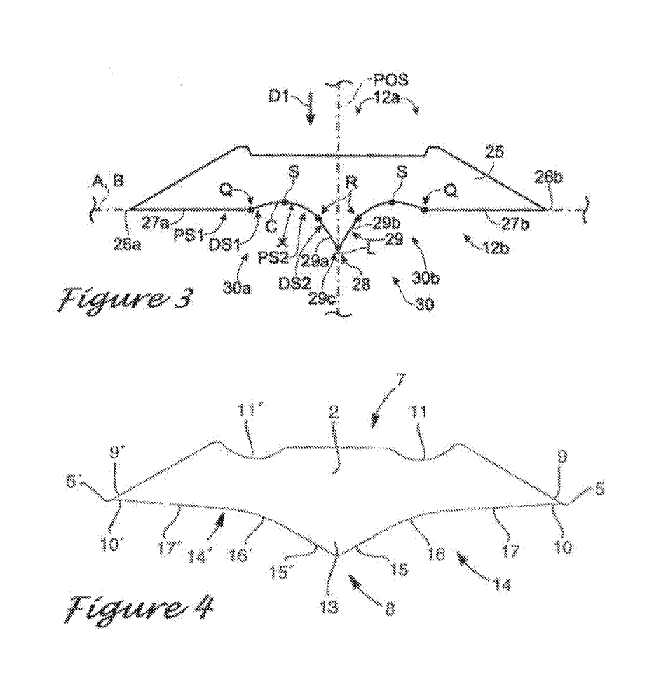

The knife comprises a top clamping zone (7) in FIG. 1, which constitutes two symmetrical areas defined by reference line 2 from FIG. 2 with each side containing two distinct angles (1) and ( 2), which are used to contact tho clamp and fix the knife in place with much more force than traditional prior art. These angles culminate in a round point (12) in the center of the clamping zone (7). This round point (12) is located on reference line 2 from FIG. 2 in the center of the knife. This top clamping zone (7) is contacted by the clamp so when the clamp bolts the knife into place there is contact. The round point (12) is not contacted by the clamp as the clamp holds the knife with force only in points (1) and (2) on each side.

This contact zone (7) terminates on each side in a flat surface (3) on each side of the contact zone. After these flat surfaces (3), a bevel lines on the knife (9) begin, which is terminated in two opposed cutting edges (4).

The bottom of the knife is defined by two parallel lines (8) on each side of She reference line 2 defined in FIG. 2, which terminate in the opposed cutting edges (4). These parallel lines define reference line 1. The knife has two iterations, one with indention lines (6), which are parallel to lines (8) and do not have contact with the counterknife and do not locate the knife in place. These indention lines end in a respective round point (11) and then continue to form the chip deflecting ridge on the knife with straight lines (5), terminating in a rounded crest point (10) which lies on the same reference line 2 as point (12). The other iteration does not have the indention lines (6).

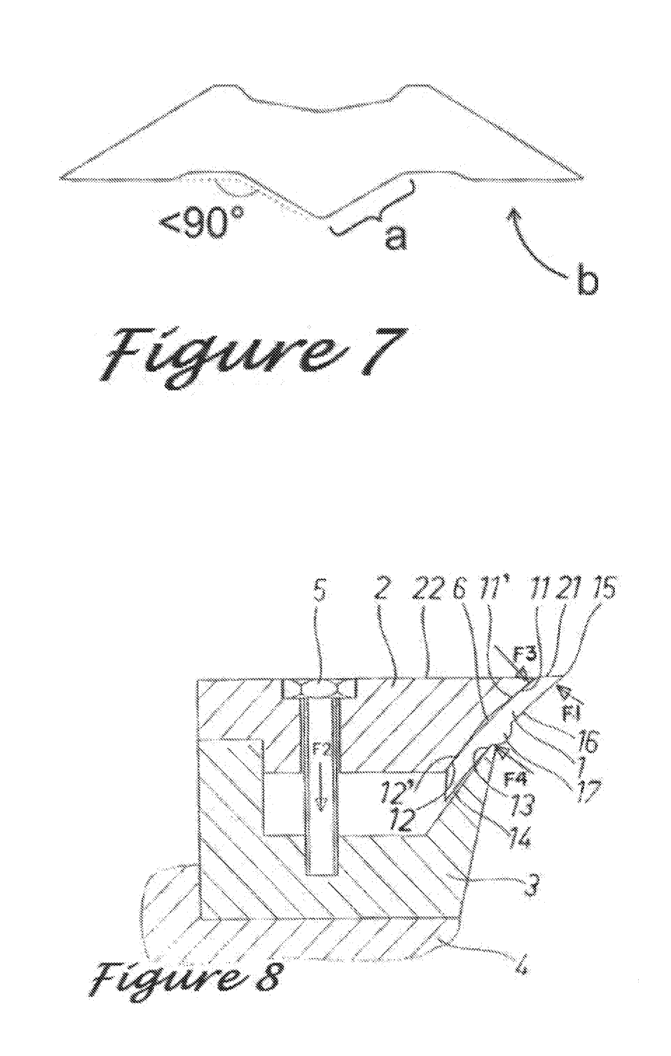

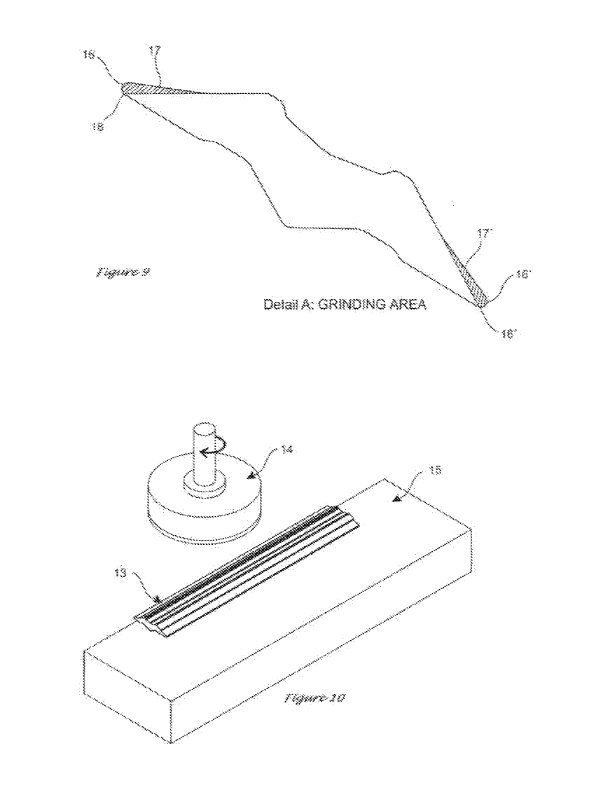

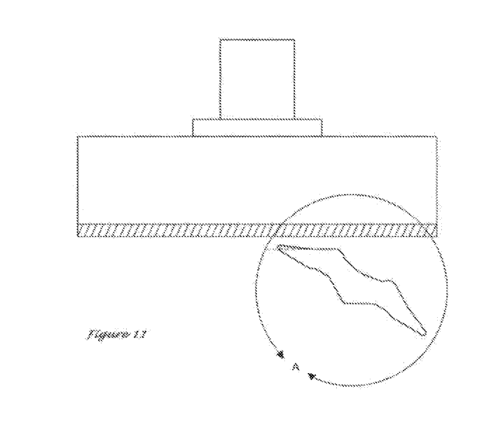

The deflector ridge on this knife is defined by the two straight lines (5), which form a triangle at point (10). The angle between (5) and parallel lines (8) must be greater than 90 degrees (see FIGS. 6 and 7)

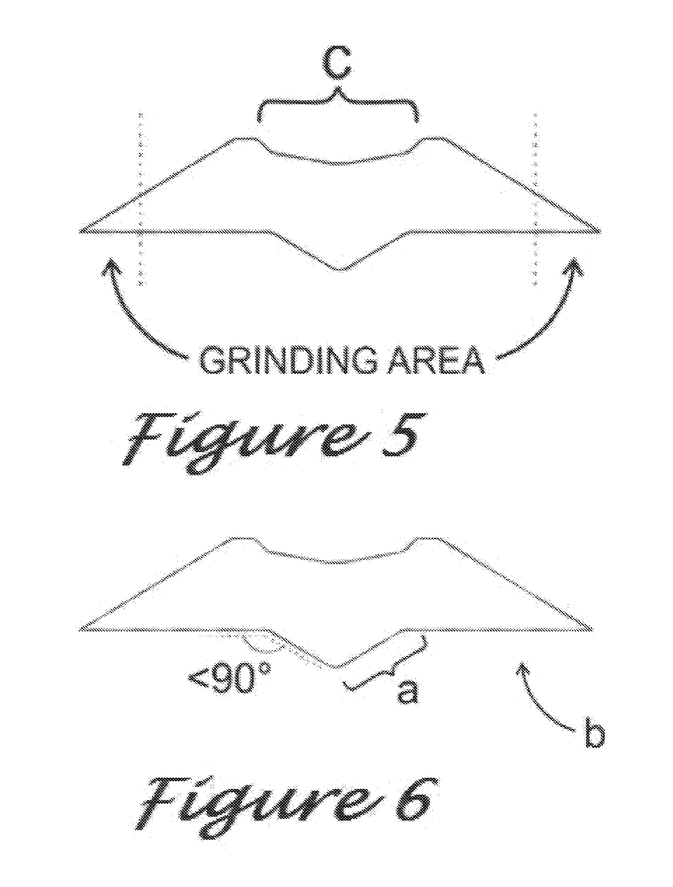

Within the wood chipping process, the objective is to cut the chip and then provide the optimal transition for the chip to pass through the disc bottom of the knife (6, 8. 11, 5), seen on FIG. 1, in order to maintain the proper chip thickness. The ridge on the bottom of the knife of the present invention is unique in that it has a flat straight portion (5) where it contacts the counterknife and the angle with respect to the linear line on the bottom of the knife is over 90 degrees. This flat portion reduces the manufacturing cost of the knife and counterknife, while also providing an optimal wood chip transition to maintain the quality of the wood chips. This is an improvement over the aggressive ridge with guiding services in patent 49.918. One iteration of the invention (see FIG. 5) is the indentions (6) with a flat surface on each side of the ridge. These indentions (6) further reduce material cost while also pushing the force of the clamp closer to the edges of the knife). This increases the stability of the knife while also reducing the material used to manufacture the knife. These indentions are unique from patent 49.918 because the indentions in patent 49.918 are used to guide and locate the knife with the counterknife (FIG. 3) and are rounded with a minimum point in the center. The indentions in this invention are not used to guide or locate the knife and there is no contact with the supporting counterknife below it. They provide added knife stability by spreading the clamping force closer to the tip of the knife.

The invention also claims a manufacturing process that uses a near-net profile for the raw material, yet this near-net profile shape is unique in that it already achieves the final dimensions of the knife and only has added material near the bevel of the knife (FIG. 9). The first step in the manufacturing process is hot rolling the steel through rolls, which creates the general shape, followed by a cold extrusion, also known as cold drawing, through multiple dies until the final shape is achieved. The above process has been used for many years in the manufacturing of knives; however, the knives are then further machined on all of the surfaces alter the heat treatment of the steel shape. This new invention achieves 80% of the final shape of the knife in the cold extrusion process and the only machining process remaining is sharpening the edges (see FIG. 5 and FIG. 9). After the cold extrusion of the knife, the knives are cut to length and then heat treated to the correct hardness. Alter heat treatment the knife is cleaned and the edges are sharpened (FIG. 9, 10, 11). This process is unique in that it eliminates the majority of the cost associated with finish grinding, which is the most expensive cost component of reversible, or indexable knife manufacturing.

1. An industrial wood chipper knife with an elongated axis terminating in two opposing parallel cutting edges, the two cutting edges each being straight in part and being separated by a ridge, where-in the ridge comprises two symmetrical straight ridge edges on either side of a central point which form an isosceles triangle where-in these ridge edges are defined by being straight and not concave or round.

2. The industrial wood chipper knife according to claim 1 the angle between a cutting edge and a ridge edge is greater than 90 degrees.

3. The industrial wood chipper knife according to claim 1 further comprising a top clamping feature that includes two distinct angles on each side where the clamp holds the knife.

4. The industrial wood chipper knife according to claim 1 further comprising two identical indention lines on each of the cutting edges, which indentation lines are parallel and terminate the ridge.

5. A method for manufacturing an industrial wood chipper knife, where in the method comprises:
a) Supplying raw material made of steel in round or square shape;
b) Hot rolling that raw material through shaped rolls to create the general form of the knife;
c) Cold drawing, or extruding, the steel through multiple dies to create a final shape, where the final shape is a wood chipper knife comprising an elongated axis terminating in two opposing cutting edges, each with a parallel straight lines separated by a ridge in the middle of the bottom side, where in the ridge on the bottom of the knife comprises two symmetrical straight lines on either side which form a triangle where in these lines are specifically defined by being straight and not being concave or round; and
d) sharpening the area near the edges.
